(19) United States
(12) Patent Application Publication
(10) Pub. No.: US 2026/0368678 A1
(43) Pub. Date: Nov. 19, 2026

(54) SYSTEMS AND METHODS FOR BANK-TRUTH-BASED LIQUIDITY GOVERNANCE, REPORTING, RECONCILIATION, AND PREDICTIVE FORECASTING

(71) Applicant: Duane Morris, Northfield, OH (US)

(72) Inventor: Duane Morris, Northfield, OH (US)

(21) Appl. No.: 19/679,703

(22) Filed: May 17, 2026

Related U.S. Application Data
(60) Provisional application No. 63/806,827, filed on May 16, 2025.

(51) Int. Cl. G06Q 10/0637; G06Q 10/067; G06Q 40/06

(52) U.S. Cl. CPC G06Q 10/06375; G06Q 40/067; G06Q 10/0672

(57) ABSTRACT

A computer-implemented method for generating a temporal-based liquidity assessment is disclosed. A computing system receives financial and operational data inputs including bank-activity data and one or more of general-ledger, accounts-receivable, accounts-payable, payroll, inventory, contract, sales-order, customer-relationship-management, budget, or batch-report data. The system maps the received data into a governed structural framework comprising organizational structure, account relationships, roll-up relationships, and liquidity classifications. The system resolves timing and settlement differences between book-state representations of transactions and bank-verified settlement activity and preserves or restores contextual attributes associated with each transaction across its lifecycle. The system may further learn transaction behavior based on prior customer-receipt and vendor-payment patterns to enhance forecasting precision using governed behavior learning and forecast precision structures. Based on bank-settled timing, the resolved timing differences, and the preserved contextual attributes, the system generates a temporal-based liquidity assessment including a current liquidity position and a forecasted liquidity position.

### FIELD

The present disclosure relates generally to computer systems, and more particularly to computer systems for bank-truth-based liquidity governance, reporting reconciliation, and predictive forecasting.

### BACKGROUND

Businesses of all sizes play a central role in the global economy, supporting employment, enabling commerce, and driving innovation across virtually every sector. Modern organizations rely on a wide range of financial, operational, and administrative activities to function effectively, and these activities generate significant volumes of information that reflect the ongoing health and performance of the enterprise. As markets evolve and economic conditions shift, organizations increasingly depend on timely and accurate information to support planning, decision-making, and long-term stability.

In many environments, organizations must track and manage a variety of resources, financial activities, and operational commitments to maintain visibility into their overall position. These activities may involve monitoring cash movements, obligations, operational events, or other business processes that influence financial outcomes. As the volume and diversity of information continue to grow, organizations often seek tools and systems that help consolidate, organize, or interpret this information in a consistent and reliable manner.

### BRIEF DESCRIPTION OF THE DRAWINGS

The structure, operation, and advantages of the present invention will become further apparent upon consideration of the following description taken in conjunction with the accompanying figures (FIGs). The figures are intended to be illustrative, not limiting.

Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

Often, similar elements may be referred to by similar numbers in various figures (FIGs) of the drawing, in which case typically the last two significant digits may be the same, the most significant digit being the number of the drawing figure (FIG). Furthermore, for clarity, some reference numbers may be omitted in certain drawings.

FIG. 1A illustrates an exemplary system diagram for bank-truth-based liquidity governance, reporting, reconciliation, and predictive forecasting, in accordance with disclosed embodiments.

FIG. 1B illustrates an exemplary liquidity assessment system, in accordance with disclosed embodiments.

FIG. 2 illustrates an exemplary financial data ingestion pipeline in accordance with disclosed embodiments.

FIG. 3 illustrates an exemplary governance overlay hierarchy in accordance with disclosed embodiments.

FIG. 4 illustrates an exemplary exception-processing workflow performed by a Universal Financial Resolution Layer (UFRL), in accordance with disclosed embodiments.

FIG. 5 illustrates an exemplary hash-based transaction key generation process in accordance with disclosed embodiments.

FIG. 6 illustrates an exemplary reconciliation of book-truth and bank-truth transaction timelines in accordance with disclosed embodiments.

FIG. 7 is a flowchart indicating steps for generating a temporal-based liquidity assessment in accordance with disclosed embodiments.

### SUMMARY

Embodiments can include a computer-implemented method for generating a temporal-based liquidity assessment, the method comprising: receiving, by a computing system, a plurality of financial and operational data inputs including bank activity data and one or more of general ledger data, accounts receivable data, accounts payable data, payroll data, inventory data, contract data, sales-order data, customer-relationship-management data, budget data, or batch-report data; mapping, by the computing system, the plurality of financial and operational data inputs into a governed structural framework comprising organizational structure, account relationships, roll-up relationships, and liquidity classifications; resolving, by the computing system, timing and settlement differences between book-state representations of transactions and bank-verified settlement activity; preserving or restoring contextual attributes of transactions across a transaction lifecycle; and generating, by the computing system, a temporal-based liquidity assessment based on bank-settled timing, the resolved timing and settlement differences, and the contextual attributes, wherein the temporal-based liquidity assessment comprises a current liquidity position and a forecasted liquidity position.

Embodiments can include a computer system, comprising: a memory storing a liquidity-governance module; a network interface configured to receive a plurality of financial and operational data inputs from one or more external data sources; and a processor communicatively coupled to the memory and the network interface, the processor executing program code of the liquidity-governance module to cause the computer system to: map the plurality of financial and operational data inputs into a governed structural framework; resolve timing and settlement differences between book-state transaction data and bank-verified settlement data; preserve or restore contextual transaction attributes across a transaction lifecycle; determine a beginning bank balance, a beginning book balance, net cash movement, an ending book balance, and an ending bank balance; and generate one or more governed liquidity outputs based on bank-settled timing and the preserved or restored contextual transaction attributes.

Embodiments can include a computer program product comprising a non-transitory computer-readable medium having program instructions stored thereon that, when executed by one or more processors of a computing system, cause the computing system to: receive a plurality of financial and operational data inputs; map the plurality of financial and operational data inputs into a governed structural framework; resolve timing and settlement differences between book-state transaction data and bank-verified settlement data; generate one or more pre-obligation forecast objects for expected or committed liquidity events prior to formal accounting recognition; determine net cash movement including operating activity and balance-sheet activity; generate one or more governed liquidity outputs including an interperiod report or a drilldown-capable explorer output; and securely distribute at least one of the one or more governed liquidity outputs according to a governance rule.

### DETAILED DESCRIPTION

Organizations often face significant challenges when attempting to obtain an accurate and timely view of their current or future liquidity position. Financial activity is frequently distributed across multiple systems, each of which may record transactions at different times, in different formats, or according to different accounting conventions. In many cases, the timing of when a transaction is recognized in a book-state system does not align with the timing of when the corresponding cash movement is reflected in bank-verified settlement data. These timing gaps, settlement delays, batch-level posting behaviors, and multi-system inconsistencies can obscure liquidity visibility, making it difficult for organizations to understand their true cash position, evaluate emerging obligations, or anticipate near-term liquidity pressure. As a result, organizations often rely on manual processes, spreadsheets, or delayed reporting cycles that fail to capture the real-time effects of settlement timing, operational events, or evolving financial conditions.

In many organizations, existing financial systems merely go through the motions of liquidity management without providing meaningful timing intelligence. Accrual-based accounting systems are designed to explain earnings, but they do not explain liquidity timing, leaving finance teams without visibility into when cash will actually move using governed accrual limitations. Forecasting tools often rely on assumed payment timing rather than measured settlement patterns, causing projections to diverge from real-world cash behavior. As a result, organizations frequently operate with timing assumptions that are disconnected from bank-verified settlement data, leading to inaccurate forecasts, unexpected liquidity dips, and limited ability to anticipate near-term obligations.

Existing enterprise resource planning (ERP) systems further exacerbate these challenges because they tend to record accounting recognition without consideration of bank-verified settlement timing. Cash reported without context regarding economic condition or timing behavior is merely activity, not intelligence, and provides little insight into emerging liquidity pressure using governed timing visibility. Because liquidity timing “lives at the bank,” organizations must manually reconcile ERP-recorded activity with bank-verified settlement outcomes, often through spreadsheets or ad-hoc processes that lack consistency, auditability, or real-time visibility. These limitations prevent organizations from understanding true liquidity posture, evaluating timing-driven risks, or generating decision-grade signals that leadership can rely on.

Disclosed embodiments mitigate the aforementioned challenges by providing a governed computational framework that unifies disparate financial and operational data into a consistent, timing-aware representation of organizational liquidity. In various implementations, the system applies a structured governance framework that normalizes incoming data, aligns transactions with organizational and account-level classifications, and preserves contextual attributes across the full transaction lifecycle. By enforcing consistent structural relationships and classification logic, the system enables downstream processes to operate on a coherent and reliable representation of financial activity, regardless of the source system or the timing conventions under which the activity was originally recorded.

To address timing mismatches and settlement uncertainty, disclosed embodiments further employ a Universal Financial Resolution Layer (UFRL) configured to reconcile book-state representations of transactions with bank-verified settlement activity. The UFRL may classify, flag, and/or route unresolved items, identify settlement-timing differences, and maintain continuity across transaction states. Complementing the UFRL, a Normalized Cash Flow Engine (NCFE) generates timing-aware liquidity outputs by incorporating bank-settled timing, contextual attributes, and scenario-based forecasting logic. Together, the UFRL layer and the NCFE engine can provide a unified computational foundation that supports accurate current-state liquidity assessments as well as forward-looking projections across operating, investing, and financing activities.

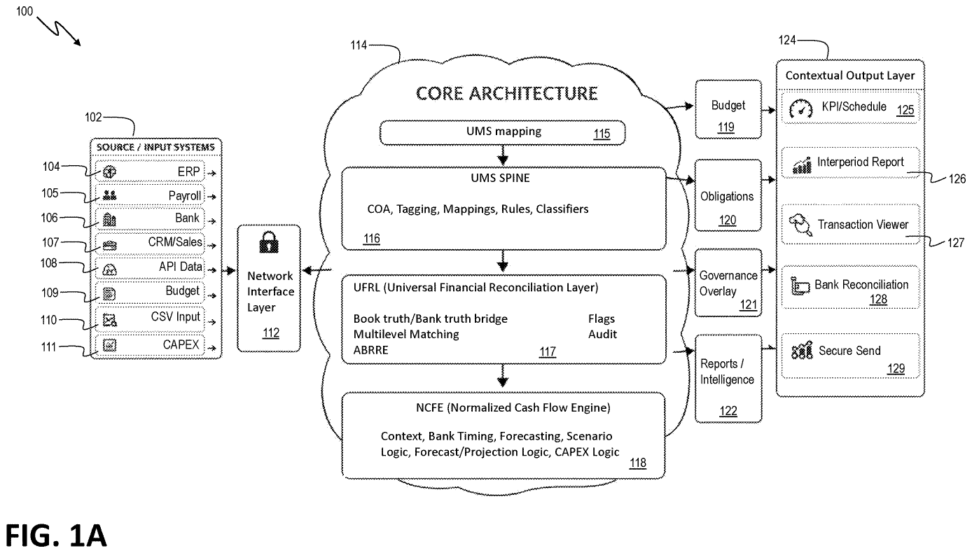

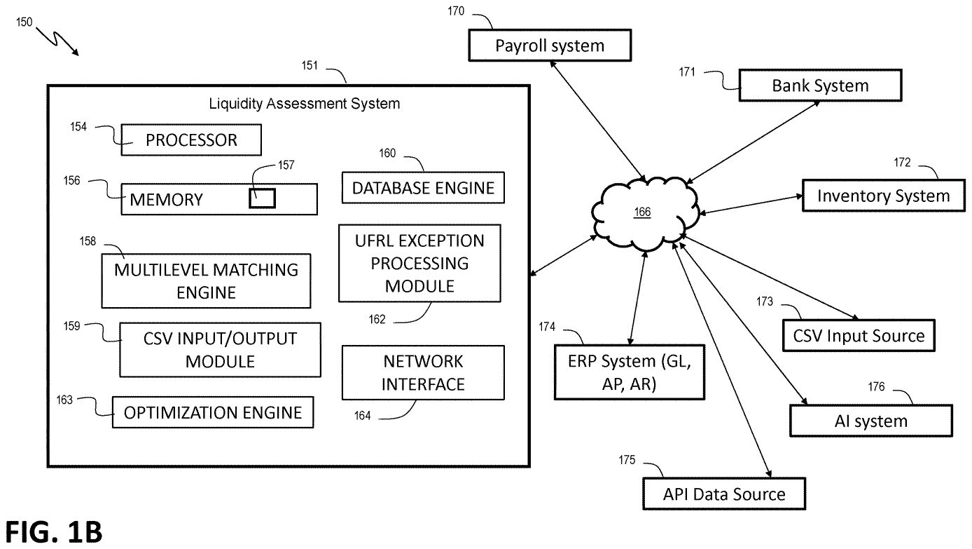

Referring now to FIG. 1A, an example architecture 100 is illustrated for processing financial and operational information to support liquidity governance and related analytical outputs. In the example shown, a set of source and input systems 102 provide various categories of enterprise data, including enterprise-resource-planning data, payroll information, bank activity, customer-relationship-management data, budget information, capital-expenditure data, and other structured or unstructured inputs. The ERP 104 can include general ledger, accounts payable, accounts receivable, subledger activity, journal entries, vendor records, customer records, and/or other accounting-system data. The payroll system 105 can include payroll-run information, net-pay amounts, tax and deduction activity, benefits-related cash flows, and/or employer-side obligations. The bank input 106 can include account balances, interest payments, debits, credits, lockbox activity, ACH and wire transactions, merchant-processor deposits, and/or other bank-verified settlement activity. The CRM/sales input 107 can include opportunity data, sales orders, contract information, customer commitments, and/or other pre-obligation or revenue-related operational signals. The API data 108 can include information received through RESTful APIs, SOAP-based services, XML feeds, JSON payloads, and/or other machine-readable interfaces that expose structured or semi-structured financial or operational data. The budget input 109 can include planned expenditures, revenue forecasts, departmental budgets, capital-allocation plans, and/or other forward-looking financial assumptions. The CSV input 110 can include delimited files exported from third-party systems, spreadsheets, and/or custom operational tools, enabling ingestion of data from environments that may not support direct integration; CSV ingestion can be advantageous because it can be integrated into almost any system and provides a flexible mechanism for bulk data transfer. The CAPEX input 111 can include capital-expenditure schedules, project-level spending, asset-acquisition data, and/or other investing-related financial activity. These input systems 102 may represent internal or external data sources, and may communicate with the platform through one or more secure interfaces or ingestion mechanisms. The diversity of these input systems reflects the wide range of operational events and financial activities that influence an organization's liquidity position.

The incoming data is received through a network interface layer 112, which may perform secure communication, authentication, normalization, or other preliminary processing functions. The network interface layer 112 provides a consistent entry point into the platform and enables the system to ingest data originating from heterogeneous systems, formats, or transport mechanisms. In various embodiments, the network interface layer may support encrypted communication protocols such as SSH, TLS, or HTTPS; application-layer interfaces such as REST, SOAP, or message-queue transports; and lower-level networking technologies including Ethernet, Gigabit Ethernet (GigE), fiber-optic links, and/or other physical-layer or data-link-layer mechanisms suitable for enterprise data exchange. These capabilities can enable disclosed embodiments to reliably receive structured or unstructured information from a wide range of internal and external environments, regardless of the underlying network topology or communication standard used by the originating system. Once received, the data is supplied to the core architecture 114, which applies a governed structural framework to unify, classify, and contextualize the incoming information. The core architecture 114 may include a mapping component 115 and a UMS spine 116 that define organizational hierarchies, chart-of-accounts relationships, tagging structures, rules, classifiers, and/or other mapping logic used to align disparate data sources into a consistent internal representation. In one or more embodiments, mapping the plurality of financial and operational data inputs into the governed structural framework comprises applying a Universal Mapping System (UMS) that defines chart-of-accounts relationships, organizational hierarchies, roll-up structures, key-performance-indicator (KPI) mappings, and one or more operating, investing, or financing classifications.

Within the core architecture 114, a Universal Financial Resolution Layer (UFRL) 117 processes book-state and bank-verified representations of financial activity to identify, classify, or resolve timing differences, settlement discrepancies, or unmatched items. The UFRL 117 may perform multilevel matching, apply flags or audit indicators, and/or route unresolved items for further processing. In some embodiments, the UFRL includes an Automated Bank Reconciliation and Resolution Engine (ABRRE) configured to support automated reconciliation operations, including identification of matched and unmatched transactions, settlement-timing differences, or other reconciliation conditions. The UFRL accordingly can establish a bridge between book-truth and bank-truth representations of financial activity, enabling downstream components to operate on a timing-accurate and context-preserved dataset. In one or more embodiments, the exception handling layer comprises a Universal Financial Resolution Layer (UFRL) implemented as an exception processing module configured to automatically classify each unmatched transaction with an exception code based on transaction attributes. In one or more embodiments, resolving timing and settlement differences comprises providing unmatched or partially resolved transaction data to a Universal Financial Resolution Layer (UFRL) configured to classify, flag, or route unresolved items based on transaction attributes or settlement conditions.

A Normalized Cash Flow Engine (NCFE) 118 operates in conjunction with the UFRL to generate timing-aware liquidity information based on contextual attributes, bank-settled timing, forecasting logic, scenario logic, projection logic, capital-expenditure logic, and/or other analytical processes. The NCFE 118 may normalize cash-flow activity across operating, investing, and financing categories, and may generate prior-state, current-state, and forward-looking liquidity representations using liquidity representations structures. For example, the NCFE may adjust projected cash inflows by incorporating actual bank-verified settlement timing, thereby replacing book-state assumptions with observed settlement behavior to produce more accurate short-term forecasts using forecasting logic. For example, the NCFE may adjust projected cash inflows by incorporating actual bank-verified settlement timing, thereby replacing book-state assumptions with observed settlement behavior to produce more accurate short-term forecasts using forecasting logic. As another example, the NCFE may evaluate multiple hypothetical scenarios, such as delayed customer receipts, accelerated vendor payments, or planned capital-expenditure events, to determine how such conditions would affect liquidity runway or cash-position trajectories using scenario analysis. These and other analytical operations enable the NCFE to produce normalized, timing-aware cash-flow outputs that reflect both historical settlement patterns and forward-looking operational expectations. One or more embodiments can include generating an interperiod liquidity report including one or more obligation views, pre-obligation forecasting views, or operating, investing, and financing activity views across multiple periods, wherein the temporal-based liquidity assessment includes historical-state, current-state, and forecasted liquidity positions.

Multiple modules may further process and/or augment data output from the core architecture 114. This can include, but is not limited to, a budget module 119, an obligations module 120, a governance overlay module 121, and a reports/intelligence module 122. The budget module 119 may include functionality for generating budget schedules, comparing actual activity to planned activity, producing variance analyses, and/or integrating forward-looking budget assumptions with normalized cash-flow information using budget modeling. The obligations module 120 may include logic for identifying, classifying, and/or projecting upcoming financial commitments such as vendor payments, payroll cycles, tax obligations, debt-service events, and/or other operational or contractual outflows. One or more embodiments can include generating a pre-obligation forecast object for an expected or committed liquidity event prior to formal billing, formal payable creation, and/or formal accounting recognition. In one or more embodiments, generating the pre-obligation forecast object comprises deriving the pre-obligation forecast object from one or more of contract data, purchase-order data, sales-order data, customer-relationship-management data, batch-report data, and/or manually entered forecast data.

The governance overlay module 121 may include rule-based structures, audience-specific views, and/or hierarchical categorizations that enforce consistent reporting conventions, access controls, and/or delivery rules across different stakeholders using a governance overlay. The reports/intelligence module 122 may include analytical tools for generating movement schedules, interperiod reports, drilldown-capable transaction explorers, bank-reconciliation views, and/or other intelligence outputs that enable users to evaluate liquidity conditions, operational drivers, and/or transaction-level detail across multiple periods or reporting contexts.

Outputs generated by the NCFE and related components are provided to a contextual output layer 124, which may include modules for budgeting, obligations, governance overlays, reporting, intelligence, and/or other analytical or operational views. These modules may generate schedules, interperiod reports, transaction-level explorers, reconciliation views, and/or secure delivery outputs, enabling users to interact with governed liquidity information in a variety of formats and levels of detail. The KPI/Schedule 125 output can include key-performance indicators such as cash-on-hand, liquidity runway, forecast variance, operating cash conversion, days sales outstanding, days payables outstanding, company-standard analytics KPIs, industry-specific KPIs, and/or other KPI metrics relevant to liquidity governance using governed company standard KPIs and industry specific KPI structures. In one or more embodiments, the net cash movement comprises a movement schedule including combined operating cash activity and balance-sheet cash activity. In one or more embodiments, the balance-sheet cash activity comprises capital-expenditure activity. In one or more embodiments, the movement schedule further comprises payroll segmentation including one or more of net payroll, payroll tax or deduction activity, and/or ERISA-related or benefits-related cash activity. In this context, ERISA refers to the Employee Retirement Income Security Act of 1974 and may include benefits-related or fiduciary-governed disbursements using governed payroll segments. In certain embodiments, payroll segmentation may further improve forecast accuracy by isolating downstream timing effects associated with payroll-tax remittances, benefits-related disbursements, and other post-payroll obligations using governed payroll timing effects structures. By distinguishing these downstream events from core payroll activity, the system may more precisely model settlement timing, recurring statutory obligations, and special payroll events, thereby enhancing the precision of short-term and medium-term liquidity forecasts using governed forecast precision structures.

In some embodiments, the system may generate budget-oriented key performance indicators (KPIs) that quantify how operational activity aligns with an approved financial plan using governed budget KPIs. A Budget Burn KPI may measure the rate at which authorized budget resources are being consumed relative to the original plan, using time-aligned book-truth and bank-truth data to determine whether spending behavior is accelerating or decelerating. A Budget Runway KPI may estimate how long remaining budget resources can sustain operations based on observed burn patterns, timing-adjusted obligations, and expected settlement behavior. A Budget Utilization KPI may track the proportion of approved budget that has been deployed across operational categories, enabling leadership to evaluate whether spending is occurring as expected or diverging from planned allocations. These budget KPIs may be computed using structured SQL operations, time-series analysis, and/or rule-based governance logic applied to normalized financial data.

In additional embodiments, the system may generate forecast-oriented KPIs that incorporate bank-timed expectations, settlement-timing intelligence, and/or projected liquidity behavior using governed forecast KPIs. A Forecast Burn KPI may estimate projected liquidity consumption based on expected inflows, obligations, and settlement timing derived from historical patterns or machine-learning-assisted timing predictions. A Forecast Runway KPI may determine how long projected liquidity can sustain operations under current or scenario-based conditions, incorporating timing-aware adjustments for pending settlements, cross-border delays, and/or currency-conversion effects. A Forecast Variance KPI may identify where projected liquidity movement diverges from actual outcomes or prior expectations, enabling early detection of timing anomalies, operational disruptions, and/or unexpected cash-flow behavior. These forecast KPIs may be computed at the database layer using indexed transaction keys, temporal-alignment logic, and/or ABRRE-driven reconciliation states to ensure that projections reflect bank-verified timing rather than purely accounting-based assumptions. The aforementioned KPIs are merely illustrative, and other embodiments may employ additional, fewer, or alternative KPIs depending on organizational structure, data availability, or analytical requirements. Disclosed embodiments may also support custom and/or domain-specific metrics that extend or replace these examples, enabling different operational contexts to generate timing-aware liquidity indicators tailored to their particular forecasting needs using governed alternative metrics structures.

The interperiod report 126 can include bank-verified cash movement across closed periods, timing-aware comparisons of expected versus actual liquidity behavior, and/or multi-period analyses of operating, investing, and financing activity. One or more embodiments can include generating interperiod liquidity data by comparing liquidity movement across multiple financial periods. One or more embodiments can include preserving or restoring contextual attributes of transactions across the transaction lifecycle by maintaining lifecycle continuity across cash-tag states including a pre-obligation state, an originating transaction-context state, a book-state or book-cash state, and a bank-verified settlement state. One or more embodiments can include generating an interperiod liquidity report including one or more obligation views, pre-obligation forecasting views, or operating, investing, and financing activity views across multiple periods.

In some embodiments, an Interperiod Intelligence module may generate liquidity intelligence across multiple accounting or operational periods, enabling the system to evaluate how liquidity moves, signals, and evolves over time using governed interperiod analysis. By aligning book-truth and bank-truth representations across closed, open, and forecasted periods, the system may transform raw transaction activity into temporal insights that support forward-looking decision-making. These interperiod evaluations may incorporate settlement-timing intelligence, exception-resolution outcomes, and cross-period behavioral patterns to provide a governed view of liquidity evolution using liquidity evolution structures.

In some embodiments, the system may generate an Interperiod Cash Report, which may reflect bank-verified liquidity movement across one or more closed periods. This report may highlight how cash actually moved, based on bank-truth settlement data, rather than how activity was recognized under accounting rules. By comparing book-recorded activity with bank-verified settlement outcomes, disclosed embodiments m may identify timing differences, delayed postings, partial settlements, and/or other discrepancies that influence liquidity visibility across periods. These interperiod cash movements may be computed using indexed transaction keys, temporal alignment logic, and/or reconciliation states maintained by the UFRL.

In other embodiments, the system may generate an Interperiod Forecast Liquidity Report, which may provide forward-looking liquidity projections based on observed settlement timing, payment behavior, and economic-condition signals across multiple periods. These projections may incorporate historical timing distributions, vendor-specific settlement patterns, and/or machine-learning-assisted timing predictions to estimate future liquidity conditions. By evaluating liquidity behavior across prior periods, disclosed embodiments may generate more accurate and timing-aware forecasts for upcoming periods, enabling organizations to anticipate liquidity constraints or operational pressure.

In further embodiments, the system may generate an Interperiod Variance Report, which may detect where expected liquidity behavior diverges from actual outcomes across periods. Variance detection may include identifying unexpected settlement delays, deviations from forecasted inflow or outflow patterns, and/or anomalies in cross-period liquidity movement. These variances may be used to trigger exception workflows, adjust forecast trajectories, and/or alert leadership to emerging liquidity risks. Variance analysis may be performed using rule-based logic, statistical deviation thresholds, and/or machine-learning-assisted anomaly detection.

In additional embodiments, the system may include an Interperiod Scenario Layer, which may evaluate how timing changes, settlement behavior, and/or operational conditions could influence future liquidity before issues become urgent. Scenario simulations may incorporate hypothetical timing shifts, cross-border settlement delays, currency-conversion effects, and/or operational disruptions to evaluate their impact on liquidity across multiple periods. These scenario-based evaluations may be used to stress-test liquidity conditions, prioritize exception queues, and/or support strategic planning across fiscal or operational cycles.

In some embodiments, an Interperiod Intelligence module may maintain cross-period reconciliation states that persist across fiscal and/or operational boundaries using governed reconciliation states. These states may capture whether a transaction was matched, partially matched, timing-delayed, exception-routed, and/or otherwise unresolved at the close of a prior period. When a new period begins, the system may propagate these reconciliation states forward, enabling downstream components to evaluate how unresolved or timing-shifted activity influences liquidity conditions in subsequent periods. In certain embodiments, the system may compute temporal dependency chains, identifying when the resolution of a prior-period transaction affects the liquidity posture of a later period using governed temporal dependencies. This cross-period state propagation may be implemented using indexed transaction keys, state-transition tables, and/or time-aligned reconciliation logs maintained by the UFRL. By preserving and evaluating these cross-period dependencies, disclosed embodiments may generate more accurate liquidity assessments, detect emerging timing risks earlier, and provide a governed view of liquidity behavior across multiple operational cycles.

The transaction viewer 127 can allow a user to navigate from high-level summaries into transaction-level detail, view supporting source references, inspect lifecycle states, and/or evaluate how individual transactions contribute to aggregate liquidity outcomes. The bank reconciliation 128 can include matched and unmatched transaction views, settlement-timing differences, transfer-to-zero evaluations, multi-currency comparisons, and/or other bank reconciliation outputs derived from the UFRL and ABRRE processes. The secure send 129 enables governed delivery of liquidity outputs to authorized recipients, applying audience rules, governance rules, encryption, and/or other access-control mechanisms to ensure that sensitive financial information is distributed in a controlled and compliant manner. One or more embodiments can include generating a drilldown-capable transaction-explorer output configured to permit navigation from a summary liquidity output to transaction-level detail and one or more supporting source references. In certain embodiments, the interperiod report 126 may be transmitted via the secure send 129 in PDF form with version control, authorized-user access, and/or secure-delivery controls, ensuring that sensitive liquidity information is distributed in a controlled, auditable, and compliant manner using governed secure delivery structures.

FIG. 1B is a block diagram 150 that includes a liquidity assessment system 151 configured to receive, process, and analyze financial and operational data from a variety of external systems. The liquidity assessment system 151 may be implemented using one or more electronic computing devices, virtualized compute instances, and/or distributed processing environments. As shown, the liquidity assessment system 151 is communicatively coupled to multiple external data sources through a network 166, which may include public or private networks such as the Internet, a virtual private network (VPN), a dedicated enterprise backbone, and/or other communication infrastructures. External systems may include a payroll system 170, a bank system 171, an inventory system 172, a CSV input source 173, an ERP system 174, and an API-based data source 175, each of which may provide structured or unstructured information relevant to liquidity governance and analysis. One or more embodiments can include ingesting a payroll schedule and generating payroll timing projections that account for irregular payroll timing events, the irregular payroll timing events comprising variations in pay cycle frequency and variations across multiple payroll types. The inventory system 172 can include expiration information for one or more products. One or more embodiments can include generating expiration aware revenue forecasts by applying discounting rules to inventory items approaching expiration based on shelf-life information. In one or more embodiments, the liquidity assessment module is further configured to generate expiration aware revenue forecasts by applying discounting rules to inventory items approaching expiration based on shelf-life information. In one or more embodiments, the liquidity assessment system is further configured to generate, at a database layer, a hash-based transaction key for each transaction, the hash-based transaction key being computed from a plurality of transaction attributes and stored in an indexed SQL structure to facilitate deterministic matching operations.

In some embodiments, CSV-based ingestion provides a flexible mechanism for integrating data from a wide variety of systems, tools, and operational environments. A CSV file may include multiple columns representing transaction attributes, account identifiers, dates, amounts, and/or other structured information, enabling straightforward parsing and transformation using scripts or utilities written in languages such as Python, Bash, or Lua. These scripts may preprocess CSV data into JSON, XML, and/or other machine-readable formats to facilitate faster ingestion into downstream components or external systems using CSV processing. CSV ingestion may be particularly useful in environments where direct API connectivity is unavailable, impractical, or cost-prohibitive. In one or more embodiments, receiving the plurality of financial data inputs comprises ingesting CSV formatted reports exported from enterprise resource planning systems, payroll systems, bank systems, or inventory systems.

Alternatively, or in conjunction with CSV ingestion, one or more APIs may be exposed to facilitate higher-performance data exchange, improved security, or real-time integration with external systems. Such APIs may utilize RESTful interfaces, JSON or XML payloads, HTTP POST or GET operations, token-based authentication, and/or other API integration mechanisms suitable for enterprise-grade data transfer. API-based ingestion may enable incremental updates, event-driven synchronization, or secure bidirectional communication between the liquidity assessment system 151 and external platforms. One or more embodiments can include receiving the plurality of financial data inputs via application programming interfaces (APIs).

The liquidity assessment system 151 includes a processor 154 configured to execute instructions 157 stored in a memory 156 for implementation of features of disclosed embodiments. In various embodiments, the processor 154 may comprise a multi-core or multithreaded architecture capable of parallel execution of reconciliation routines, mapping logic, forecasting operations, and/or other computational tasks. The processor may be implemented using x86, ARM, RISC-V, or other processor architectures, and may optionally include hardware-accelerated features such as vector instruction sets, cryptographic extensions, or trusted execution environments. The processor 154 may further interface with specialized modules such as a multilevel matching engine 158 or an optimization engine 163 to offload computationally intensive operations.

In some embodiments, the system may be deployed in a cloud-enabled or virtualized computing environment that supports scalable execution of reconciliation, forecasting, and governance operations using governed containerized execution. The processor 154 and associated components may operate within container frameworks such as Docker-compatible containers, virtual machines managed by a hypervisor, or orchestration platforms such as Kubernetes or similar cluster-management systems using governed cloud orchestration. In certain embodiments, the system may dynamically allocate compute resources based on workload intensity, enabling horizontal scaling of reconciliation pipelines, ABRRE processes, or forecasting engines. The architecture may further support multi-tenant isolation, rolling updates, and distributed execution across cloud regions or availability zones, allowing the system to maintain performance and resiliency under varying operational conditions.

The memory 156 stores program code and runtime data used by the liquidity assessment system 151. In one or more embodiments, the memory may include volatile memory such as DRAM or SRAM for active execution, and non-volatile memory such as flash storage or solid-state drives for persistent configuration data, reconciliation states, mapping definitions, and/or historical liquidity records. The memory 156 may also store a CSV input/output module 159, which enables ingestion and export of delimited files from third-party systems, spreadsheets, and/or custom operational tools. CSV-based ingestion may be used to integrate environments that lack direct API connectivity or require bulk-file transfer mechanisms.

The system further includes a multilevel matching engine 158 configured to compare book-state and bank-verified representations of financial activity across multiple dimensions, such as amount, date, counterparty, and/or transaction type. The multilevel matching engine 158 may operate in conjunction with a UFRL exception processing module 162, which classifies, flags, and/or routes unresolved items for additional analysis. A database engine 160 can provide structured storage and query capabilities for normalized financial data, reconciliation states, transaction attributes, and other information used by the platform. The database engine may support SQL-based operations, indexing strategies, and/or other database-engine features suitable for high-volume financial processing. In one or more embodiments, reconciling book truth values with bank truth values further comprises performing automated bank reconciliation using deterministic matching rules and settlement timing patterns.

In some embodiments, the architecture may further include an AI system 176 configured to supplement or review the analysis performed by the liquidity assessment system 151. The AI system 176 may operate as an advisory or validation layer that applies machine-learning models, anomaly-detection logic, and/or pattern-recognition techniques to normalized financial and operational data. In certain embodiments, the AI system 176 may evaluate reconciliation outcomes, timing-difference classifications, and/or forecast projections generated by the liquidity assessment system 151 and may provide confidence scores, exception-risk indicators, or alternative interpretations of observed cash-flow behavior. The AI system 176 may also identify unusual settlement patterns, emerging liquidity risks, or deviations from expected operational activity, enabling the overall system to incorporate both deterministic governance logic and data-driven analytical insight.

A network interface 164 can enable the liquidity assessment system 151 to communicate with external systems 170-176 through the network 166. The network interface may support secure communication protocols such as TLS or HTTPS, as well as lower-level networking technologies including Ethernet, Gigabit Ethernet, fiber-optic links, or other physical-layer or data-link-layer mechanisms. The network may include a LAN, WAN, the Internet, and/or other suitable networks. Through network 166, the system may receive financial and operational data, transmit governed liquidity outputs, and/or interact with external services that provide supplemental information used in reconciliation, forecasting, or reporting workflows.

One or more embodiments can include a computer implemented method for generating a temporal based liquidity assessment, the method comprising: receiving, by a computing system, a plurality of financial data inputs including general ledger data, accounts receivable data, accounts payable data, payroll data, bank activity data, and inventory data; assigning cash behavior tags to transactions represented in the financial data inputs, each cash behavior tag indicating timing characteristics, settlement behavior, and contextual attributes of a corresponding transaction; reconciling book truth values with bank truth values by identifying timing differences between accounting recognition of a transaction and bank verified settlement of the transaction; matching transactions across the financial data inputs using deterministic matching rules to associate bank activity records with corresponding accounting records; routing unmatched transactions to an exception handling layer for exception processing; and generating a temporal based liquidity assessment based on the cash behavior tags, the reconciled transactions, and observed settlement timing patterns, wherein the temporal based liquidity assessment includes a plurality of liquidity indicators, and wherein the plurality of liquidity indicators include a current liquidity position and a forecasted liquidity position.

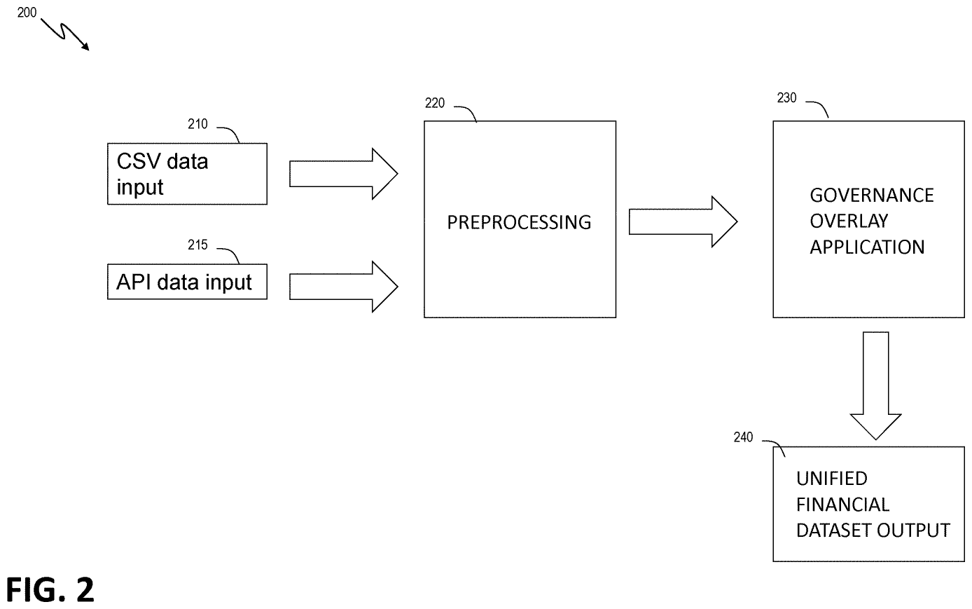

FIG. 2 illustrates an exemplary financial data ingestion pipeline 200 in accordance with disclosed embodiments. The pipeline receives financial and operational information from multiple heterogeneous sources and transforms the information into a unified dataset suitable for downstream reconciliation, governance, and/or liquidity-analysis operations. As shown, the pipeline may include a CSV data input 210 and an API data input 215, each of which provides structured or semi-structured information relevant to financial activity. These inputs may originate from enterprise systems, third-party platforms, operational tools, or other environments that expose data through file-based interfaces or programmatic endpoints. The ingestion pipeline thereby enables the system to consolidate information from diverse environments into a consistent internal representation using data ingestion.

The CSV data input 210 may include delimited files containing transaction records, account identifiers, dates, amounts, and/or other financial attributes. CSV-based ingestion may be used to integrate systems that lack direct API connectivity or rely on batch-oriented export processes. In some embodiments, CSV files may be preprocessed using scripts or utilities to validate formatting, normalize field structures, and/or convert the data into intermediate representations suitable for downstream processing. The API data input 215 may include information received through RESTful interfaces, SOAP-based services, XML feeds, JSON payloads, or other machine-readable formats. API-based ingestion may support incremental updates, event-driven synchronization, and/or real-time integration with external systems, enabling the platform to maintain an up-to-date representation of financial activity.

Both the CSV data input 210 and the API data input 215 may be supplied to a preprocessing stage 220. The preprocessing stage 220 may perform operations such as parsing, type normalization, field mapping, timestamp alignment, duplicate detection, schema validation, and/or other transformations that prepare the incoming data for governed processing. By applying these transformations, the preprocessing stage 220 ensures that heterogeneous inputs can be evaluated consistently, regardless of the originating system or the formatting conventions used to represent the underlying financial activity.

Following preprocessing, the data may be provided to a governance overlay application 230, which applies structural, organizational, and classification logic to the normalized information. The governance overlay may enforce chart-of-accounts relationships, organizational hierarchies, roll-up structures, liquidity classifications, and/or other rule-based mappings that align the incoming data with a governed internal framework using a governance overlay. By applying these mappings, the governance overlay application 230 can produce a consistent and context-aware representation of financial activity suitable for downstream reconciliation, matching, forecasting, and/or reporting operations. In one or more embodiments, the liquidity assessment module further comprises a governance overlay including a multi-level financial category hierarchy stored in a universal general ledger structure, the universal general ledger structure defining parent child category relationships used to perform deterministic roll up and roll down operations.

The output of the governance overlay application 230 is provided to a unified financial dataset output 240. This dataset may represent a normalized, governed, and timing-aware view of financial activity that can be consumed by other components of the platform, including reconciliation engines, liquidity-forecasting modules, reporting tools, and/or drilldown-capable transaction explorers. The unified dataset enables the system to perform accurate liquidity assessments, evaluate operational drivers, and generate governed outputs across multiple analytical or reporting contexts. One or more embodiments can include applying a governance overlay, the governance overlay comprising a multi-level financial-category hierarchy stored in a universal general-ledger structure, the universal general-ledger structure defining parent-child category relationships used to perform deterministic roll-up and roll-down operations. One or more embodiments can include generating a governed delivery output and securely distributing one or more liquidity outputs to one or more authorized recipients according to a recipient rule, audience rule, and/or governance rule. In some embodiments, the system may generate a drilldown-capable explorer output, which refers to an interactive, hierarchical representation of normalized financial or operational data using governed drilldown navigation. The explorer output may allow a user or downstream process to begin at an aggregated liquidity, account, and/or category level and progressively navigate into increasingly granular components, such as individual transactions, timing-difference classifications, and/or contextual attributes. In certain embodiments, the drilldown-capable explorer output may be produced as a structured data object, table, and/or visualization that preserves parent-child relationships, roll-up logic, and classification metadata using governed hierarchical explorer structures. This enables the system to present both summary-level and detail-level information within a unified, navigable output format. In one or more embodiments, the one or more liquidity outputs comprise one or more of a movement schedule, an interperiod report, a drilldown-capable explorer output, a bank-application forensic output, a covenant-monitoring output, and/or a major-funder output.

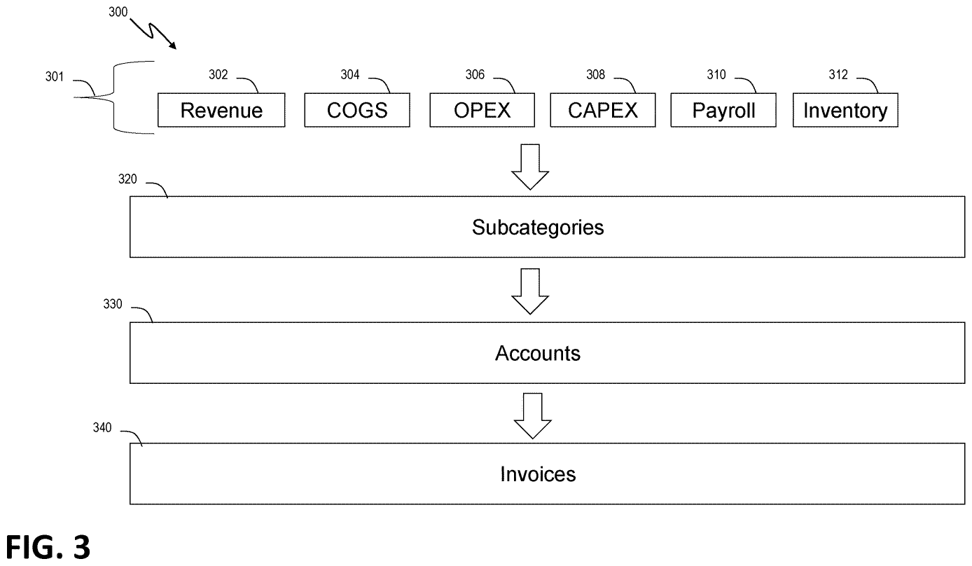

FIG. 3 illustrates an exemplary governance overlay hierarchy 300 in accordance with disclosed embodiments. In the example shown, a set of high-level financial categories 301, such as Revenue 302, Cost of Goods Sold (COGS) 304, Operating Expenses (OPEX) 306, Capital Expenditures (CAPEX) 308, Payroll 310, and Inventory 312, form the upper tier of a governed classification structure. These categories may represent organizationally significant groupings used for liquidity analysis, reporting, forecasting, and/or compliance-driven financial oversight. The governance overlay provides a consistent framework for interpreting and organizing financial activity across disparate systems, enabling the platform to apply uniform logic regardless of the originating data source using a governance hierarchy.

In some embodiments, the system may account for asymmetric payroll timing, where weekly and bi-weekly payroll cycles do not align evenly with calendar months using governed payroll timing structures. For example, weekly payroll cycles may result in five payroll disbursements in certain months rather than the typical four, and bi-weekly cycles may produce three payroll events in certain months rather than the expected two. These asymmetric periods may create timing distortions in both book-truth and bank-truth representations, leading to irregular liquidity consumption patterns, misleading month-over-month comparisons, and/or unexpected short-term liquidity pressure using governed asymmetric periods. In some embodiments, the system may detect these irregular payroll months automatically, adjust liquidity forecasts to reflect the additional disbursement, and incorporate timing-aware projections into the temporal-based liquidity assessment. By modeling these asymmetric payroll cycles explicitly, the system may provide more accurate visibility into payroll-driven liquidity movement and reduce the operational uncertainty associated with irregular payroll timing

Beneath the financial categories 301, the hierarchy may include one or more subcategories 320 that further refine the classification of financial activity. Subcategories may represent departmental groupings, cost centers, project codes, operational domains, and/or other intermediate structures that provide additional granularity. These governed subcategories allow the system to maintain consistent roll-up and roll-down behavior, ensuring that financial activity can be aggregated or disaggregated in a predictable manner across reporting, forecasting, and reconciliation workflows. The governance overlay may enforce naming conventions, structural relationships, and/or rule-based mappings that align incoming data with the appropriate subcategory.

Below the subcategory layer, the hierarchy may include an accounts tier 330, which may correspond to general-ledger accounts, subledger accounts, and/or other accounting-system identifiers. The governance overlay may map incoming transactions to governed account structures based on attributes such as transaction type, counterparty, operational context, and/or system-specific metadata. By applying governed account-level mappings, disclosed embodiments can ensure that financial activity is consistently represented across book-state and bank-state views, enabling accurate reconciliation, timing analysis, and liquidity classification using governed financial categories.

At the lowest tier of the illustrated hierarchy, invoices 340 or other transaction-level records may be associated with governed accounts and subcategories. This level of granularity enables drilldown-capable analysis, transaction-level auditability, and lifecycle tracking across operational and financial systems. The governance overlay may preserve contextual attributes, enforce classification rules, and maintain parent-child relationships across all levels of the hierarchy, thereby producing a unified, governed representation of financial activity suitable for downstream reconciliation, forecasting, reporting, and liquidity-governance operations. One or more embodiments can include determining a beginning bank balance, applying one or more reconciling items to derive a beginning book balance, applying net cash movement to derive an ending book balance, and determining an ending bank balance based on the ending book balance and one or more reconciling items.

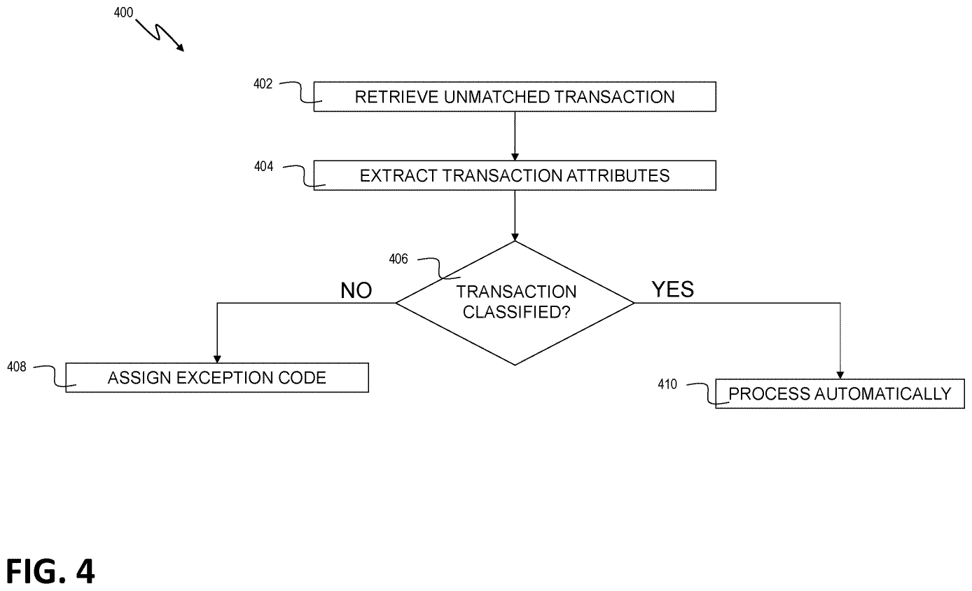

FIG. 4 illustrates an exemplary exception-processing flowchart 400 indicating process steps that may be performed by a Universal Financial Resolution Layer (UFRL), in accordance with disclosed embodiments. The workflow begins by retrieving an unmatched transaction at block 402, which may represent a financial activity for which a corresponding bank-verified settlement record has not yet been identified. Unmatched transactions may arise due to timing differences, partial settlements, data-quality issues, and/or operational events that cause book-state and bank-state representations to diverge. The UFRL can retrieve such transactions for further analysis as part of its governed exception processing responsibilities.

Once an unmatched transaction is retrieved, disclosed embodiments may extract transaction attributes at block 404, including amount, date, counterparty, account identifiers, operational context, and/or other metadata relevant to classification. These attributes may be evaluated using rule-based logic, machine-readable mappings, and/or multilevel matching criteria to determine whether the transaction can be associated with a known settlement pattern, timing behavior, and/or operational category. Attribute extraction enables the UFRL to apply consistent governance logic across heterogeneous data sources and ensures that downstream classification decisions are based on normalized and context-aware information.

The workflow then determines whether the transaction can be classified at block 406. If the transaction satisfies one or more classification rules, the system may process the transaction automatically at block 410. Automatic processing may include applying settlement-timing adjustments, updating reconciliation states, generating liquidity-impact calculations, and/or performing other governed operations that align book-truth and bank-truth representations. In some embodiments, automatic processing may be performed by an ABRRE process, which is configured to identify matched transactions, unmatched transactions, settlement-timing differences, and/or transfer residuals using structured SQL operations at a database layer. The ABRRE process may evaluate internal transfer activity to determine whether a transfer-to-zero condition is satisfied, enabling automated resolution of internal movements that net to zero across accounts using governed ABRRE process logic. In certain embodiments, evaluation of transfer-to-zero conditions may also function as a fraud-prevention mechanism by identifying incomplete, asymmetric, or unexpected internal-transfer patterns that deviate from expected zero-balance behavior using governed fraud prevention and internal transfer controls structures.

In one or more embodiments, resolving the one or more reconciling items comprises performing automated bank reconciliation using an ABRRE process configured to identify matched transactions, unmatched transactions, settlement timing differences, and/or transfer residuals, wherein one or more reconciliation, matching, settlement-resolution, and/or liquidity-calculation operations are performed at a database layer comprising a structured SQL environment prior to generation of an output. In some embodiments, the ABRRE process may further comprise determining whether internal transfer activity satisfies a transfer-to-zero condition, wherein a set of related internal transfers is expected to net to zero across designated accounts, business units, and/or ledger structures using governed internal transfers. For example, internal sweeps, intercompany transfers, and/or zero-balance-account operations may be configured such that the aggregate effect of the transfers should reduce one or more accounts to a zero balance or otherwise produce a net-zero result across the participating accounts using governed zero-balance conditions. Disclosed embodiments may evaluate book-state postings and bank-verified settlement activity to determine whether the expected zero-balance condition has been achieved, and may identify timing gaps, partial postings, and/or missing settlement events when the transfer-to-zero condition is not satisfied. In one or more embodiments, the ABRRE process further comprises determining whether internal transfer activity satisfies a transfer-to-zero condition. In one or more embodiments, the ABRRE process further comprises reconciling transaction activity involving multiple currencies by comparing book-state values and bank-settlement values across differing currencies or settlement rates. In one or more embodiments, the ABRRE process further comprises reconciling credit-card or merchant-processor settlement activity by associating gross transaction activity with net deposited cash after one or more of fees, reserves, chargebacks, holdbacks, or batch-level settlement adjustments.

If the transaction cannot be classified, the workflow assigns an exception code at block 408. Exception codes may indicate conditions such as missing attributes, ambiguous matches, timing anomalies, or operational inconsistencies that require additional review. The UFRL may apply flags, audit indicators, or routing rules to ensure that unresolved items are escalated appropriately for further analysis. By assigning exception codes and preserving contextual metadata, the UFRL maintains a governed bridge between book-truth and bank-truth representations, enabling accurate reconciliation, auditability, and downstream liquidity-governance operations. One or more embodiments can include routing unmatched transactions to the exception handling layer comprises providing the unmatched transactions to a Universal Financial Resolution Layer (UFRL) implemented as an exception processing module, the exception processing module being configured to automatically classify each unmatched transaction with an exception code based on transaction attributes.

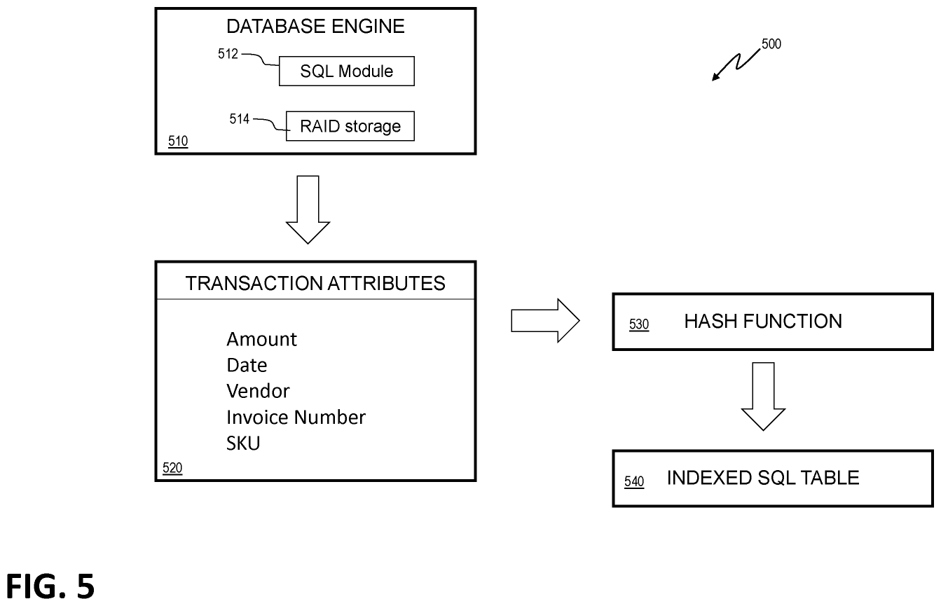

FIG. 5 illustrates an exemplary hash-based transaction key generation process 500 in accordance with disclosed embodiments. In the example shown, a database engine 510 receives transaction-level information and generates a compact, fixed-length transaction key that can be used to accelerate lookup, matching, and reconciliation operations. The database engine 510 may include an SQL module 512 and RAID storage 514, which together provide structured query capabilities, durable persistence, and high-throughput access to financial data. By generating a hash-based transaction key at the database layer, the system reduces the need for repeated multi-field comparisons and enables more efficient indexing strategies that improve performance during reconciliation, matching, and liquidity-calculation workflows using governed hash keys. In various embodiments, the hash function may include MD5, SHA-256, SHA-384, SHA-512, BLAKE2, or other secure and computationally efficient hashing algorithms well-suited for high-volume data processing. These algorithms may be selected based on collision-resistance requirements, throughput characteristics, or compatibility with database-layer optimization strategies using governed hash algorithms. By collapsing multiple transaction attributes into a fixed-length hash value, disclosed embodiments can reduce memory consumption, improve cache locality, and accelerate lookup operations across large financial datasets.

A set of transaction attributes 520, such as amount, date, vendor, invoice number, and SKU, may be extracted from incoming financial activity. These attributes may originate from heterogeneous systems and may vary in length, format, or structure. In conventional systems, matching or reconciling such transactions often requires repeated comparisons across multiple fields, which increases CPU usage, memory consumption, and disk I/O. In contrast, disclosed embodiments apply a hash function 530 to these attributes to generate a deterministic, fixed-size transaction key. The hash function may be implemented using a cryptographic or non-cryptographic hashing algorithm, depending on performance requirements, collision-tolerance thresholds, and/or other system constraints. The resulting hash value provides a compact representation of the underlying attributes, enabling faster comparisons and reduced memory footprint. In one or more embodiments, the liquidity assessment module is further configured to perform a multi-level matching process including a first level general ledger match, a second level invoice level match, and a third level SKU level match.

The generated hash-based transaction key may be stored in an indexed SQL table 540. Because the hash value is fixed in size and significantly smaller than the combined attribute set, the indexed table can store more entries per page, reduce page-split frequency, and improve cache locality. These characteristics enable the database engine to perform high-speed lookups, joins, and matching operations with substantially fewer disk accesses or memory operations than would be required using full-attribute comparisons. In some embodiments, the indexed SQL table may support B-tree, hash-index, and/or other SQL indexing structures optimized for fixed-length keys, further improving throughput during reconciliation and forecasting operations. Depending on deployment requirements, the indexed structure may be implemented using MySQL, PostgreSQL, Microsoft SQL Server, and/or other relational database platforms that support optimized index types for fixed-size keys. In alternative embodiments, NoSQL environments such as MongoDB, Cassandra, or DynamoDB may be used to store hash-based keys within document-oriented or key-value schemas, enabling horizontal scaling and distributed lookup performance using governed database schemas. These indexing and storage strategies allow the system to process large volumes of financial transactions with reduced disk I/O, faster retrieval times, and improved scalability across reconciliation and liquidity-governance workflows

By generating and indexing hash-based transaction keys at the database layer, the system achieves computer-specific improvements that enhance the performance of downstream processes such as multilevel matching, ABRRE reconciliation, exception handling, and liquidity-calculation routines. These improvements may include reduced memory usage, faster lookup times, lower CPU overhead, and improved scalability when processing large volumes of financial transactions. The hash-based approach also enables deterministic matching behavior, allowing the system to efficiently identify duplicates, detect settlement-timing differences, and/or resolve reconciling items across book-truth and bank-truth representations. As a result, the hash-based transaction key generation process provides a technical foundation for high-performance liquidity governance and reconciliation operations. In one or more embodiments, matching transactions across the financial data inputs further comprises generating, at a database layer, a hash-based transaction key for each transaction, the hash-based transaction key being computed from a plurality of transaction attributes and stored in an indexed SQL structure to facilitate deterministic matching operations.

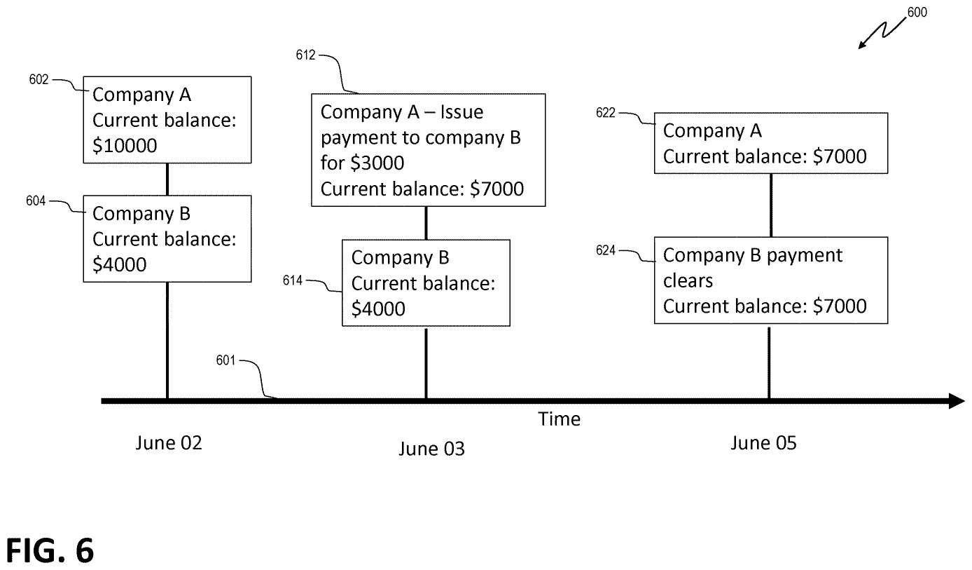

FIG. 6 illustrates an exemplary reconciliation of book-truth and bank-truth transaction timelines in accordance with disclosed embodiments. In the example 600 shown, referring to the timeline 601, on June 2 at block 602, the initial conditions include Company A having a current balance of $10,000. Similarly, at block 604, Company B is indicated as having a balance of $4,000. On June 3, as indicated at block 612, Company A initiates a payment to Company B on June 3, reducing Company A's book-state balance immediately while Company B's book-state balance remains unchanged until the payment is recognized, as shown at block 614. However, the corresponding bank-truth settlement does not occur until June 5, at which point, the balance for Company A as shown at block 622 is similar to that shown in block 612, while, as shown at block 624, Company B's bank-verified balance increases. This timing gap demonstrates a common scenario in which book-recorded activity and bank-verified settlement data diverge, creating uncertainty in short-term liquidity assessments and operational decision-making using governed timing difference logic. In one or more embodiments, generating the temporal-based liquidity assessment comprises computing payment-timing projections using invoice-aging data, vendor-priority rankings, and current liquidity conditions.

The illustrated timeline highlights how even a single transaction can produce asymmetric visibility across the two parties. Company A experiences an immediate reduction in its book-state balance, while Company B does not see the corresponding increase until the bank clears the payment. Without a governed reconciliation process, these timing differences can obscure the true liquidity position of each entity, complicating forecasting, cash-position reporting, and intra-period liquidity management. Disclosed embodiments address this challenge by applying structured governance logic, timing-aware reconciliation rules, and multilevel matching techniques to align book-truth and bank-truth representations.

In some embodiments, the Universal Financial Resolution Layer (UFRL) may evaluate the illustrated transaction using rule-based matching, settlement-timing intelligence, and ABRRE-driven reconciliation logic. The UFRL may identify the transaction as a timing-difference case, apply flags or audit indicators, and update reconciliation states once the bank-truth settlement is observed. By bridging book-truth and bank-truth timelines, the system provides a governed foundation for accurate liquidity analysis, enabling downstream components to generate timing-aware forecasts, obligations schedules, and liquidity-impact calculations using governed liquidity governance structures.

The example shown in FIG. 6 represents a simplified scenario involving a single payment between two entities. In practice, organizations may experience thousands of such timing differences across multiple accounts, currencies, payment rails, settlement windows, and operational systems. Additional factors, such as partial settlements, batch-level posting behavior, internal transfers, merchant-processor delays, and/or cross-border settlement cycles, may further complicate liquidity visibility. Disclosed embodiments provide a governed, scalable framework capable of reconciling these complex, real-world conditions to support accurate and timely liquidity assessment.

In some embodiments, the system may further account for cross-border settlement timing, where book-truth and bank-truth representations may diverge due to jurisdiction-specific posting windows, regional banking holidays, currency-conversion delays, and/or payment-rail processing constraints using governed cross-border settlement logic. For example, a payment initiated in USD by a U.S.-based entity may not be reflected in the receiving party's EUR-denominated bank account until one or more intermediary correspondent banks complete their processing cycles. These delays may introduce additional timing differences beyond those illustrated in FIG. 6, particularly when transactions traverse multiple time zones or rely on settlement networks with variable cut-off times. In certain embodiments, the system may incorporate foreign-exchange conversion timestamps, cross-currency settlement rules, and/or region-specific posting behaviors into its reconciliation and liquidity-assessment workflows. By modeling these cross-border effects, disclosed embodiments may generate more accurate international liquidity assessments, enabling organizations to anticipate settlement delays, evaluate currency-specific liquidity exposure, and maintain governed visibility across multi-jurisdictional financial operations using international liquidity structures. In additional embodiments, the system may incorporate tariff schedules and duty-rate structures to determine landed-cost values, where base cost plus applicable tariff yields a governed landed cost representation. Tariff-schedule attributes may be associated with the invoice, SKU, and transaction record, enabling the NCFE to contextualize cross-border financial activity with item-level cost structures using governed tariff schedules and classification logic.

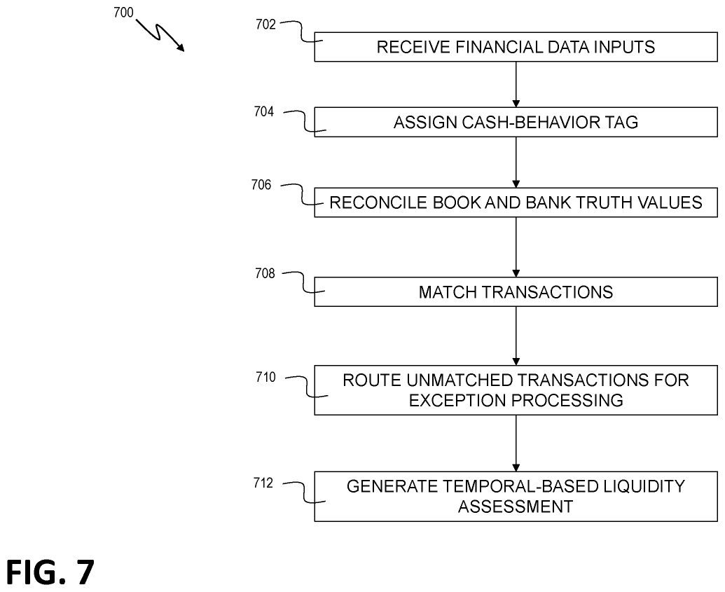

FIG. 7 is a flowchart 700 indicating process steps for generating a temporal-based liquidity assessment in accordance with disclosed embodiments. At block 702, financial data inputs are received. These inputs may include book-state records, bank-verified settlement activity, operational signals, budget information, and/or other structured or unstructured data originating from internal or external systems. In one or more embodiments, the received data may be normalized, validated, and/or preprocessed to ensure that downstream components operate on consistent and governed information using a unified ingestion framework.

At block 704, the system assigns a cash-behavior tag to the incoming transaction or financial activity. The cash-behavior tag may indicate whether the activity represents an inflow, outflow, transfer, accrual, adjustment, and/or other liquidity-relevant behavior using governed cash behavior tags. In some embodiments, the tag assignment may be based on transaction attributes, counterparty information, operational context, and/or rule-based classification logic defined within a governance overlay. Assigning a cash-behavior tag enables the system to interpret the liquidity impact of each transaction consistently across heterogeneous data sources.

At block 706, the system reconciles book-truth and bank-truth values. This may include identifying timing differences, settlement delays, partial postings, and/or other discrepancies between book-recorded activity and bank-verified settlement data. In one or more embodiments, the reconciliation process may utilize multilevel matching logic, ABRRE-driven settlement evaluation, and/or exception-processing routines to align the two representations. At block 708, the system matches transactions using governed rules, hash-based transaction keys, and/or other matching criteria. Matching may occur across multiple dimensions such as amount, date, counterparty, and/or transaction type, enabling the system to determine whether a transaction has been fully or partially resolved. In one or more embodiments, matching transactions across the financial data inputs comprises performing a multi-level matching process including a first level general ledger match, a second level invoice level match, and a third level SKU level match.

At block 710, unmatched transactions are routed for exception processing. This may include assigning exception codes, applying flags, and/or invoking UFRL-based workflows to classify or resolve outstanding items. Exception routing ensures that unresolved transactions do not distort liquidity calculations and that timing-difference cases are handled in a governed and auditable manner. At block 712, the system generates a temporal-based liquidity assessment, which may incorporate bank-settled timing, forecasted activity, scenario-based adjustments, and governed classification logic using temporal liquidity structures. The resulting assessment provides a timing-aware representation of liquidity conditions suitable for forecasting, reporting, and operational decision-making.

In some embodiments, one or more machine-learning (ML) models and/or Financial AI Agents may be incorporated into the liquidity-assessment workflow to enhance classification accuracy, reduce manual review, and/or identify anomalous financial activity using governed ML models and financial artificial intelligence (AI) agent structures. Such models or agents may be trained on historical book-truth and bank-truth data, settlement-timing patterns, exception-processing outcomes, and/or other contextual attributes relevant to liquidity behavior using governed machine-learning logic. The models or agents may assist in predicting whether a transaction is likely to match automatically, require timing-difference handling, and/or be routed for exception processing. By learning from prior reconciliation outcomes, the system may improve the efficiency and accuracy of transaction classification over time. In embodiments, such functionality may be implemented, at least in part, by AI system 176 (FIG. 1B).

In additional embodiments, machine-learning techniques may be used to flag potential issues for human inspection, such as unusual settlement delays, inconsistent counterparty behavior, duplicate transactions, and/or deviations from expected cash-behavior patterns. These models may employ supervised, unsupervised, and/or semi-supervised learning approaches, including clustering, anomaly detection, and/or probabilistic scoring using governed anomaly detection logic. The output of such models may be used to prioritize exception queues, recommend corrective actions, and/or provide early warnings regarding liquidity-impacting events. Although FIG. 7 illustrates a rule-based workflow, machine-learning-assisted embodiments may operate in parallel with or in support of the governed processes described herein.

In further embodiments, machine-learning models may be used to enhance forecasting and timing-prediction accuracy within the liquidity-assessment workflow. These models may analyze historical settlement patterns, vendor-specific behaviors, payment-rail characteristics, and/or intra-period timing distributions to estimate when pending transactions are likely to settle. By learning from prior book-truth and bank-truth divergences, the models may generate probabilistic timing estimates that improve the accuracy of short-term liquidity projections using governed forecasting models. Such timing-aware predictions may be incorporated into the temporal-based liquidity assessment to provide more reliable visibility into expected cash positions.

In additional embodiments, machine-learning techniques may support scenario simulation or risk-scoring operations. For example, the system may evaluate how liquidity conditions would change under hypothetical delays, accelerated settlements, unexpected vendor behavior, and/or operational anomalies. Models may generate scenario-based scores indicating the likelihood of timing disruptions, reconciliation failures, or liquidity-impacting events. These scores may be used to prioritize exception queues, adjust forecast trajectories, and/or trigger alerts for human review. By integrating ML-driven scenario intelligence with governed liquidity-governance structures, disclosed embodiments may provide more resilient and adaptive liquidity-assessment capabilities.

In some embodiments, the system may incorporate a supervised learning pipeline in which historical reconciliation outcomes are used to train classification or anomaly-detection models. Transactions that were incorrectly flagged as exceptions, as well as transactions that were not flagged but were later determined to be problematic, may be labeled and stored in a governed training dataset using supervised training. These labeled examples may be used to refine model parameters, improve classification accuracy, and reduce false positives and false negatives over time. The training process may occur periodically or continuously, enabling the system to adapt to evolving operational patterns, seasonal behaviors, and/or changes in settlement timing. By incorporating governed training workflows, disclosed embodiments can provide a technical mechanism for improving automated decision-making and reducing manual review burdens.

Embodiments can include a computer system, comprising: a memory storing a liquidity assessment module; a network interface configured to enable the computer system to connect to, and exchange data with, one or more external data sources; and a processor communicatively coupled to the memory and the network interface, the processor executing program code of the liquidity assessment module to cause the computer system to: receive a plurality of financial data inputs including general ledger data, accounts receivable data, accounts payable data, payroll data, bank activity data, and inventory data; assign cash behavior tags to transactions represented in the financial data inputs, each cash behavior tag indicating timing characteristics, settlement behavior, and contextual attributes of a corresponding transaction; reconcile book truth values with bank truth values by identifying timing differences between accounting recognition of a transaction and bank verified settlement of the transaction; match transactions across the financial data inputs using deterministic matching rules to associate bank activity records with corresponding accounting records; route unmatched transactions to an exception handling layer for exception processing; and generate a temporal based liquidity assessment based on the cash behavior tags, the reconciled transactions, and observed settlement timing patterns, wherein the temporal based liquidity assessment includes a plurality of liquidity indicators, and wherein the plurality of liquidity indicators include a current liquidity position and a forecasted liquidity position.

Embodiments can include a non-transitory computer readable medium having program instructions stored thereon that, when executed by one or more processors of a computing system, cause the computing system to: receive a plurality of financial data inputs including general ledger data, accounts receivable data, accounts payable data, payroll data, bank activity data, and inventory data; assign cash behavior tags to transactions represented in the financial data inputs, each cash behavior tag indicating timing characteristics, settlement behavior, and contextual attributes of a corresponding transaction; reconcile book truth values with bank truth values by identifying timing differences between accounting recognition of a transaction and bank verified settlement of the transaction; match transactions across the financial data inputs using deterministic matching rules to associate bank activity records with corresponding accounting records; route unmatched transactions to an exception handling layer for exception processing; and generate a temporal based liquidity assessment based on the cash behavior tags, the reconciled transactions, and observed settlement timing patterns, wherein the temporal based liquidity assessment includes a plurality of liquidity indicators, and wherein the plurality of liquidity indicators include a current liquidity position and a forecasted liquidity position. In one or more embodiments, the program instructions further cause the computing system to apply a governance overlay comprising a multi-level financial category hierarchy stored in a universal general ledger structure, the universal general ledger structure defining parent child category relationships used to perform deterministic roll up and roll down operations.

In some embodiments, the system may support multi-currency financial activity, enabling governed mappings between currencies such as U.S. dollars (USD), euros (EUR), Japanese yen (JPY), British pounds (GBP), and other fiat denominations using governed foreign exchange structures. The system may maintain exchange-rate tables, apply time-stamped conversion factors, and/or incorporate market-driven pricing feeds to normalize financial activity into a common liquidity-calculation currency. In certain embodiments, the system may evaluate foreign-exchange (FX) trends, such as strengthening or weakening of USD relative to EUR, JPY, or other currency pairs, to adjust liquidity forecasts, scenario simulations, or timing-aware projections. These FX-aware adjustments may improve the accuracy of cross-border liquidity assessments, particularly for organizations operating in multiple jurisdictions. In additional embodiments, the system may support non-fiat currencies, including digital assets or cryptocurrencies, by treating them as governed currency classes with associated conversion rules, volatility-adjusted liquidity weights, and/or risk-scoring parameters. Such embodiments can enable the platform to reconcile, classify, and forecast liquidity across both traditional and emerging currency types while maintaining consistent governance structures.

In some embodiments, the disclosed governance and resolution architecture may be applied to logistics and supply-chain operations, enabling the system to process physical-movement documents and operational events using governed supply chain events structures. The system may ingest bills of lading, shipping logs, receiving records, carrier-status updates, custody-handoff events, and/or inventory-movement records through real-time API integrations and/or batch-level CSV imports. These physical-movement inputs may be mapped into the same governed structural framework used for financial and operational data, including organizational structure, roll-up relationships, and classification rules. In certain embodiments, the system may normalize and align these logistics events with corresponding financial activity, enabling a unified view of operational, financial, and policy truth across both physical and monetary flows. In additional embodiments, logistics and supply-chain records may be stored or replicated within an append-only ledger or blockchain-based mechanism to provide tamper-evident recording of physical-movement events, custody transitions, or inventory-state changes using governed blockchain storage structures. In certain embodiments, inventory-movement and supply-chain records may additionally be stored, replicated, or validated using an append-only ledger and/or blockchain-based mechanism, providing a tamper-evident implementation path for governed physical-movement and custody-transition events using one or more blockchain storage structures.

In additional embodiments, the system may resolve timing differences between physical-movement events and their associated financial transactions, such as invoice issuance, payment initiation, or bank-verified settlement. For example, a shipment may be recorded as delivered in a carrier log before the corresponding receiving record is posted in an inventory system, or an invoice may be recognized before the related payment is settled at the bank. The system may preserve contextual attributes across these operational and financial lifecycles, enabling downstream components to evaluate how physical-movement timing influences liquidity, obligations, or policy compliance. By applying the same resolution-layer architecture to both financial and logistics data, the system may support a unified operational-financial governance model that can be expanded or refined in future embodiments.

As can now be appreciated, disclosed embodiments provide a governed framework for generating decision-grade liquidity intelligence by unifying bank-verified settlement timing, book-truth representations, operational signals, and temporal-based forecasting logic. In some embodiments, the system may generate a Liquidity Runway Forecast, which may determine how long available liquidity can sustain operations based on bank-verified settlement timing, pending obligations, and timing-aware projections using governed liquidity runway structures. The system may further support Timing-Aware Forecasting, in which cash-flow projections are derived from real settlement patterns rather than accounting-based assumptions, enabling more accurate and operationally relevant liquidity assessments using governed timing-aware forecasting. These capabilities allow organizations to evaluate liquidity conditions with a level of precision that reflects actual settlement behavior rather than estimated or recognition-based timing.

As can further be appreciated, disclosed embodiments may generate Priority Payment Signals, which may identify obligations that must be satisfied first to protect liquidity, maintain operational continuity, or avoid timing-driven shortfalls. In some embodiments, the system may perform Economic Condition Detection, distinguishing real financial condition from accounting presentation by evaluating settlement timing, behavioral patterns, and cross-period liquidity movement. Additional embodiments may support Board-Ready Liquidity Reporting, providing leadership with clear visibility into timing risk, liquidity posture, and emerging pressure across operational periods. The system may also generate Decision-Grade Signals, transforming normalized financial data into actionable indicators that executives can rely on for immediate decision-making. These signals may incorporate reconciliation states, timing-difference classifications, scenario-based adjustments, and cross-period intelligence to provide a governed, high-fidelity representation of liquidity health.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, computer-implemented methods, processor-implemented methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A computer-implemented method for generating a temporal-based liquidity assessment, the method comprising:
receiving, by a computing system, a plurality of financial and operational data inputs including bank activity data and one or more of general ledger data, accounts receivable data, accounts payable data, payroll data, inventory data, contract data, sales-order data, customer-relationship-management data, budget data, or batch-report data;
mapping, by the computing system, the plurality of financial and operational data inputs into a governed structural framework comprising organizational structure, account relationships, roll-up relationships, and liquidity classifications;
resolving, by the computing system, timing and settlement differences between book-state representations of transactions and bank-verified settlement activity;
preserving or restoring contextual attributes of transactions across a transaction lifecycle; and
generating, by the computing system, a temporal-based liquidity assessment based on bank-settled timing, the resolved timing and settlement differences, and the contextual attributes, wherein the temporal-based liquidity assessment comprises a current liquidity position.

2. The computer-implemented method of claim 1, wherein mapping the plurality of financial and operational data inputs into the governed structural framework comprises applying a Universal Mapping System (UMS) that defines chart-of-accounts relationships, organizational hierarchies, roll-up structures, key-performance-indicator mappings, and one or more operating, investing, or financing classifications.

3. The computer-implemented method of claim 1, wherein preserving or restoring contextual attributes of transactions across the transaction lifecycle comprises maintaining lifecycle continuity across cash-tag states including a pre-obligation state, an originating transaction-context state, a book-state or book-cash state, and a bank-verified settlement state.

4. The computer-implemented method of claim 1, further comprising generating a pre-obligation forecast object for an expected or committed liquidity event prior to formal billing, formal payable creation, or formal accounting recognition.

5. The computer-implemented method of claim 4, wherein generating the pre-obligation forecast object comprises deriving the pre-obligation forecast object from one or more of contract data, purchase-order data, sales-order data, customer-relationship-management data, batch-report data, or manually entered forecast data.

6. The computer-implemented method of claim 1, wherein resolving timing and settlement differences comprises providing unmatched or partially resolved transaction data to a Universal Financial Resolution Layer (UFRL) configured to classify, flag, or route unresolved items based on transaction attributes or settlement conditions.

7. The computer-implemented method of claim 1, further comprising determining a beginning bank balance, applying one or more reconciling items to derive a beginning book balance, applying net cash movement to derive an ending book balance, and determining an ending bank balance based on the ending book balance and one or more reconciling items.

8. The computer-implemented method of claim 7, wherein the net cash movement comprises a movement schedule including combined operating cash activity and balance-sheet cash activity.

9. The computer-implemented method of claim 8, wherein the balance-sheet cash activity comprises capital expenditure activity.

10. The computer-implemented method of claim 8, wherein the movement schedule further comprises payroll segmentation including one or more of net payroll, payroll tax or deduction activity, or ERISA-related or benefits-related cash activity.

11. The computer-implemented method of claim 7, wherein resolving the one or more reconciling items comprises performing automated bank reconciliation using an Automated Bank Reconciliation and Resolution Engine (ABRRE) process configured to identify matched transactions, unmatched transactions, settlement timing differences, or transfer residuals, wherein one or more reconciliation, matching, settlement-resolution, or liquidity-calculation operations are performed at a database layer comprising a structured SQL environment prior to generation of an output.

12. The computer-implemented method of claim 11, wherein the ABRRE process further comprises determining whether internal transfer activity satisfies a transfer-to-zero condition.

13. The computer-implemented method of claim 11, wherein the ABRRE process further comprises reconciling transaction activity involving multiple currencies by comparing book-state values and bank-settlement values across differing currencies or settlement rates.

14. The computer-implemented method of claim 11, wherein the ABRRE process further comprises reconciling credit-card or merchant-processor settlement activity by associating gross transaction activity with net deposited cash after one or more of fees, reserves, chargebacks, holdbacks, or batch-level settlement adjustments.

15. The computer-implemented method of claim 1, further comprising generating an interperiod liquidity report including one or more obligation views, pre-obligation forecasting views, or operating, investing, and financing activity views across multiple periods, wherein the temporal-based liquidity assessment includes historical-state, current-state, and forecasted liquidity positions.

16. The computer-implemented method of claim 1, further comprising generating a drilldown-capable transaction-explorer output configured to permit navigation from a summary liquidity output to transaction-level detail and one or more supporting source references.

17. The computer-implemented method of claim 1, further comprising generating a governed delivery output and securely distributing one or more liquidity outputs to one or more authorized recipients according to a recipient rule, audience rule, or governance rule.

18. The computer-implemented method of claim 17, wherein the one or more liquidity outputs comprise one or more of a movement schedule, an interperiod report, a drilldown-capable explorer output, a bank-application forensic output, a covenant-monitoring output, or a major-funder output.

19. A computer system, comprising:
a memory storing a liquidity-governance module;
a network interface configured to receive a plurality of financial and operational data inputs from one or more external data sources; and
a processor communicatively coupled to the memory and the network interface, the processor executing program code of the liquidity-governance module to cause the computer system to:
map the plurality of financial and operational data inputs into a governed structural framework;
resolve timing and settlement differences between book-state transaction data and bank-verified settlement data;
preserve or restore contextual transaction attributes across a transaction lifecycle;
determine a beginning bank balance, a beginning book balance, net cash movement, an ending book balance, and an ending bank balance; and
generate one or more governed liquidity outputs based on bank-settled timing and the preserved or restored contextual transaction attributes.

20. A computer program product comprising a non-transitory computer-readable medium having program instructions stored thereon that, when executed by one or more processors of a computing system, cause the computing system to:
receive a plurality of financial and operational data inputs;
map the plurality of financial and operational data inputs into a governed structural framework;
resolve timing and settlement differences between book-state transaction data and bank-verified settlement data;
generate one or more pre-obligation forecast objects for expected or committed liquidity events prior to formal accounting recognition;
determine net cash movement including operating activity and balance-sheet activity;
generate one or more governed liquidity outputs including an interperiod report or a drilldown-capable explorer output; and
securely distribute at least one of the one or more governed liquidity outputs according to a governance rule.
